(19) United States
(12) Patent Application Publication
(10) Pub. No.: US 2012/0173331 A1
(43) Pub. Date: Jul. 5, 2012

(54) Hint-Enabled Search Advertisements

(75) Inventors: Tchavdar Atanassov Dangaltchev, Bellevue, WA (US); Praveen Chakravarthy Sattaru, Bellevue, WA (US)

(73) Assignee: MICROSOFT CORPORATION, Redmond, WA (US)

(21) Appl. No.: 12/981,168

(22) Filed: Dec. 29, 2010

(51) Int. Cl. G06Q 30/00

(52) U.S. Cl. 705/14.49; 705/14.73

(57) ABSTRACT

Systems, methods, and computer media for providing advertisement hints, as well as keyword search query results graphical user interfaces, are provided. A keyword search query area is capable of receiving a keyword search query from a user. At least one search result area displays an Internet web page link and corresponding text relevant to a received user keyword search query. At least one search advertisement area displays an advertisement comprising an Internet web page link and corresponding text. User interaction with the advertisement area causes an advertisement hint to appear proximate to the advertisement area.

### BACKGROUND

Internet searching has become increasingly common in recent years. Search providers have taken advantage of the value of Internet searching by selling advertising space on search results pages to advertisers. Advertisers typically purchase particular search keywords such that when a user searches with a purchased keyword, the advertisements for the advertisers' products will display on the search results page. Search advertisements conventionally include a hyperlink to the advertiser's website and a text summary or description. Search advertisements, however, often fail to distinguish themselves from other search advertisements included in a search results page. Search advertisements also generally do a poor job of attracting user attention with their visual appearance, because search advertisements conventionally rely on being placed in the first position in a search results page rather than on being placed according to visual appearance to best attract user attention. Additionally, a user may be reluctant to click on a search advertisement if the user has limited time or does not want to open a new window or navigate away from the search results page.

### SUMMARY

Embodiments of the present invention relate systems, methods, and computer media for providing advertisement hints as well as keyword search query results graphical user interfaces. A user interface described herein includes a keyword search query area capable of receiving a keyword search query from a user. At least one search result area in the user interface displays an Internet web page link and corresponding text relevant to a received user keyword search query. At least one search advertisement area displays an advertisement comprising an Internet web page link and corresponding text. User interaction with the advertisement area causes an advertisement hint to appear proximate to the advertisement area. The advertisement hint is related to the advertisement.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of a prior art search engine user interface;

FIG. 3 is a block diagram of an exemplary search results page user interface in which an advertisement hint is displayed proximate to an advertisement area upon user interaction with the advertisement area in accordance with embodiments of the present invention;

FIG. 4A illustrates a possible display location of an advertisement hint proximate to an advertisement area in accordance with embodiments of the present invention;

FIG. 4B illustrates another possible display location of an advertisement hint proximate to an advertisement area in accordance with embodiments of the present invention;

FIG. 5 is a block diagram of an exemplary search results page user interface in which an advertisement area is expanded downward to incorporate an advertisement hint upon user interaction with the advertisement area in accordance with embodiments of the present invention; and

FIG. 6 is a flow chart of an exemplary method for providing advertisement hints.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention relate systems, methods, and computer media for providing advertisement hints as well as keyword search query results graphical user interfaces. In accordance with embodiments of the present invention, hint-enabled advertisements are included in a search results page for presentation to a user. When a user interacts with a hint-enabled advertisement by, for example, hovering over the advertisement with a mouse cursor, an advertisement hint related to the advertisement appears near the advertisement.

As discussed above, search advertisements often fail to distinguish themselves from other search advertisements included in a search results page. Search advertisements also typically do a poor job of attracting user attention with their visual appearance, instead relying on being placed in the first position in a search results page rather than on their visual appearance to attract user attention. Hint-enabled advertisements are powerful visual tools that allow additional information such as a product image, web page preview, logo, or additional text content that will attract a user's attention to appear near an advertisement when a user interacts with the advertisement. Additionally, hint-enabled advertisements allow a user to view more information than is present in a conventional search advertisement without navigating away from the search results page or opening a new window.

In one embodiment of the present invention, a keyword search query results user interface is provided. The user interface comprises a keyword search query entry area capable of receiving a user keyword search query. The user interface also comprises at least one search result area, each search result area displaying an Internet web page link and corresponding text relevant to a received user keyword search query. The user interface further comprises at least one search advertisement area, each search advertisement area displaying an advertisement comprising an Internet web page link and corresponding text. User interaction with the advertisement area causes an advertisement hint to appear proximate to the advertisement area. The advertisement hint is related to the advertisement.

In another embodiment, a search query is received from a user. A plurality of web pages relevant to the search query are identified. An advertisement is identified that is hint-enabled such that user interaction with the advertisement causes an advertisement hint to appear proximate to the advertisement. A search results page is then generated. The search results page includes at least one of the identified web pages relevant to the user query and the identified hint-enabled advertisement. An indication of user interaction with the hint-enabled advertisement is received. In response to the received indication of user interaction, instructions are transmitted to display the advertisement hint proximate to the advertisement.

In still another embodiment, a keyword search query results user interface is provided. The user interface comprises a keyword search query entry area capable of receiving a user keyword search query. The user interface also comprises at least one search result area, each search result area displaying an Internet web page link and corresponding text relevant to a received user keyword search query. The user interface further comprises at least one search advertisement area, each search advertisement area displaying an advertisement comprising an Internet web page link and corresponding text. User interaction with the advertisement area causes the advertisement area to expand, causes an advertisement hint to appear in the expanded advertisement area, and causes search advertisement and search result areas below the expanded area to move down to accommodate the expanded advertisement area. The advertisement hint is related to the advertisement.

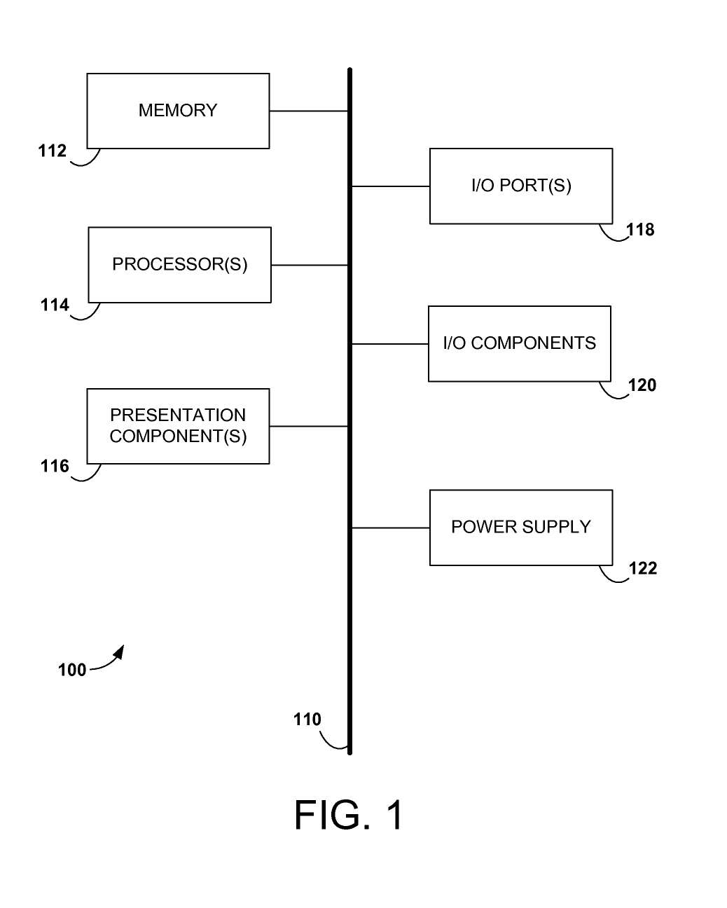

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

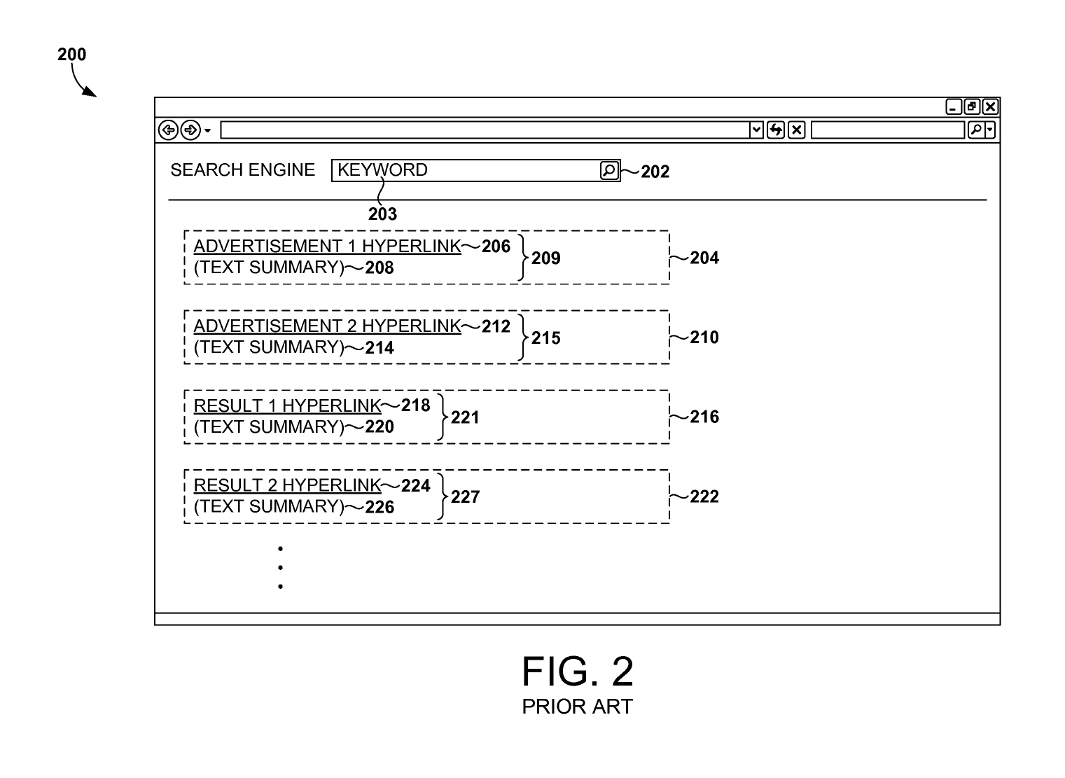

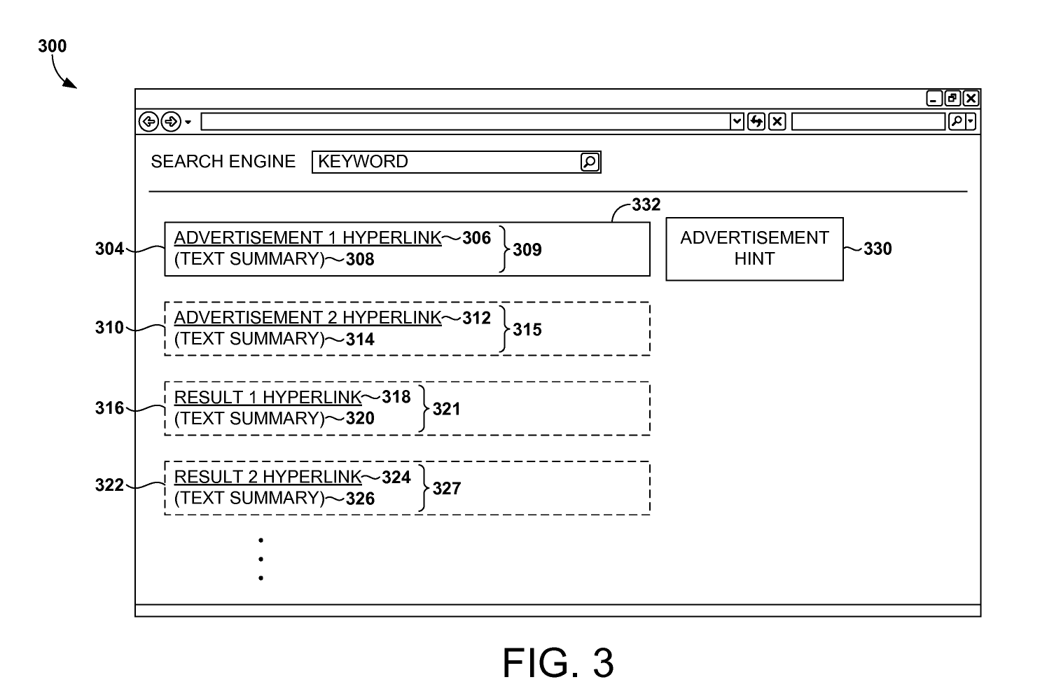

As discussed previously, embodiments of the present invention relate to hint-enabled search advertisements. A conventional search results user interface is discussed with in reference to FIG. 2. Embodiments of the present invention will be discussed in reference to FIGS. 3-6.

FIG. 2 illustrates a conventional search result page 200. Search result page 200 is generated after a user enters a search keyword 203 or group of keywords into keyword search query entry area 202, and a search query is performed. Search result page 200 includes search advertisement area 204. Search advertisement area 204 displays a search advertisement 209 comprising advertisement 1 hyperlink 206 and corresponding text summary 208. Search advertisement area 210 displays a search advertisement 215 comprising advertisement 2 hyperlink 212 and corresponding text summary 214. Search advertisements such as search advertisements 209 and 215 typically do not contain images or information other than text. Advertisement 1 hyperlink 206 and advertisement 2 hyperlink 212 are links to web pages where more information can be found regarding the advertised product or service. Text summaries 208 and 214 may describe, among other things, a promotion, product qualities, awards won, or product advantage over competitive products.

Search result area 216 displays a search result 221 comprising result 1 hyperlink 218 and corresponding text summary 220. Search result area 222 displays a search result 227 comprising result 2 hyperlink 224 and corresponding text summary 226. Search results 221 and 227 are determined by the search provider to be relevant to received user keyword 203 and are typically ranked in order of decreasing relevance such that the search result 221 is more relevant than search result 227. Result 1 hyperlink 218 and result 2 hyperlink 224 link to web pages where the relevant content is found. Text summaries 220 and 226 are typically a brief summary of the content or a portion of the content that includes entered keyword 203.

As discussed above, in a conventional keyword query search results user interface such as search results page 200, search advertisements 209 and 215 do not visually attract user attention. Search ads 209 and 215 are listed above search results 221 and 227 but are otherwise unremarkable. FIGS. 3-6 illustrate the use of hint-enabled search ads that cause an advertisement hint to appear proximate to an advertisement area in accordance with embodiments of the present invention.

FIG. 3 illustrates a search result page 300. Search result page 300 includes search advertisement area 304. Search advertisement area 304 displays a search advertisement 309 comprising advertisement 1 hyperlink 306 and corresponding text summary 308. Search advertisement area 310 displays a search advertisement 315 comprising advertisement 2 hyperlink 312 and corresponding text summary 314. Search result area 316 displays a search result 321 comprising result 1 hyperlink 318 and corresponding text summary 320. Search result area 322 displays a search result 327 comprising result 2 hyperlink 324 and corresponding text summary 326.

Search advertisement 309 is a hint-enabled advertisement. In contrast to conventional search advertisements, such as search ads 209 and 215 in FIG. 2, user interaction with the advertisement area of a hint-enabled advertisement causes an advertisement hint to appear proximate to the advertisement area. The advertisement hint is related to the advertisement. In FIG. 3, a user has interacted with advertisement area 304, causing advertisement hint 330 to appear proximate to advertisement area 304. Advertisement hint 330 may be anything related to the advertisement, including an image of a logo, product, web page, or spokesperson associated with the advertisement. For example, if a car company has placed advertisement 309, advertisement hint 330 can be an image of the car model being advertised or the logo of the car manufacturer.

A user may interact with an advertisement area in a number of ways. User interaction includes but is not limited to: hovering a selection indicator such as a mouse cursor over the advertisement area; selecting the advertisement area through a mouse click or touch or stylus input; and rolling over the advertisement area with a mouse cursor, finger, or stylus. In one embodiment, the user interaction is hovering a selection indicator over the advertisement area. In such embodiments, a mouse cursor moved to an advertisement area causes an advertisement hint to appear. In some embodiments, the system interprets a user continuing to view search results page 300 as user interaction, and the advertisement hint for each hint-enabled advertisement is displayed one after the other. For example, a first advertisement hint might be displayed for a first hint-enabled advertisement for 5 seconds and then disappear. A second advertisement hint might then be displayed for a second hint-enabled advertisement for 5 seconds and then disappear, etc.

Advertisement hint 330 may also include action links that, when interacted with by a user, perform an action or navigate a user to a website or web page associated with the advertisement. In one embodiment, interaction with the action links is accomplished through selection of the action links using a mouse cursor click or touch or stylus input. The action links can take the form of buttons or icons. An action link may, for example, navigate a user to a web page associated with the advertiser to buy, determine remaining inventory for, or obtain a quote for an advertised product. An action link could also identify local retailers or dealers for the advertised product. In some embodiments, the action link opens a small window or displays additional information in a pop-up window such that the user is not navigated away from search results page 300.

Advertisement hint 330 may also include additional text content that was not included in text summary 308 of advertisement 309. For example, a particular promotion may be too detailed to adequately express in the small amount of space provided by text summary 308, and additional details can be provided in advertisement hint 330. The additional text content can also be text designed to attract a user's attention such as “SALE!”, “YEAR-END EVENT!”, or other text content.

Advertisement area 304 is the portion of search results page 300 occupied by advertisement 309. In conventional search ads, the advertisement area is not outlined or otherwise demarcated. In one embodiment, advertisement area 304 is outlined or otherwise emphasized as shown in FIG. 3 upon user interaction with advertisement area 304. The emphasis distinguishes advertisement 309 from advertisement 315 and indicates that advertisement hint 330 is associated with advertisement 309. Other forms of emphasis of search advertisement area 304 include highlighting, graying, bolding, italicizing, or displaying an icon or symbol. In one embodiment, advertisement area 304 may shift slightly, for example up and right, upon user interaction to indicate that advertisement 309 displayed in advertisement area 304 is associated with advertisement hint 330 that appeared as a result of the user interaction.

In some embodiments advertisement area 304 includes a hint indicator that alerts a user that interaction with advertisement area 304 will display advertisement hint 330. In this way, a user can quickly identify which ads have hints available and can interact with those ads. This is especially useful in situations where not all search ads are hint-enabled. For example, a symbol may be included in advertisement area 304 to alert a user that advertisement 309 is hint-enabled. In some embodiments, the advertisement areas of hint-enabled advertisements are outlined, highlighted, edge-highlighted, or otherwise emphasized to indicate that the advertisement is hint-enabled.

In some embodiments, advertisement hint 330 is only displayed while the user interaction is ongoing. For example, if user interaction is accomplished using a mouse cursor hover, advertisement hint 330 persists while the mouse cursor is hovering over advertisement area 304 but disappears when the mouse cursor is moved away from advertisement area 304. In other embodiments, advertisement hint 330 persists until a second action is taken, such as hovering over another advertisement area or search result area or user-initiated deselection or selection of another advertisement area or search result area. Advertisement hint 330 can be any size. In one embodiment, advertisement hint 330 is large enough to accommodate an image sufficient to convey useful information but small enough so as to not interfere with other information displayed on search results page 300.

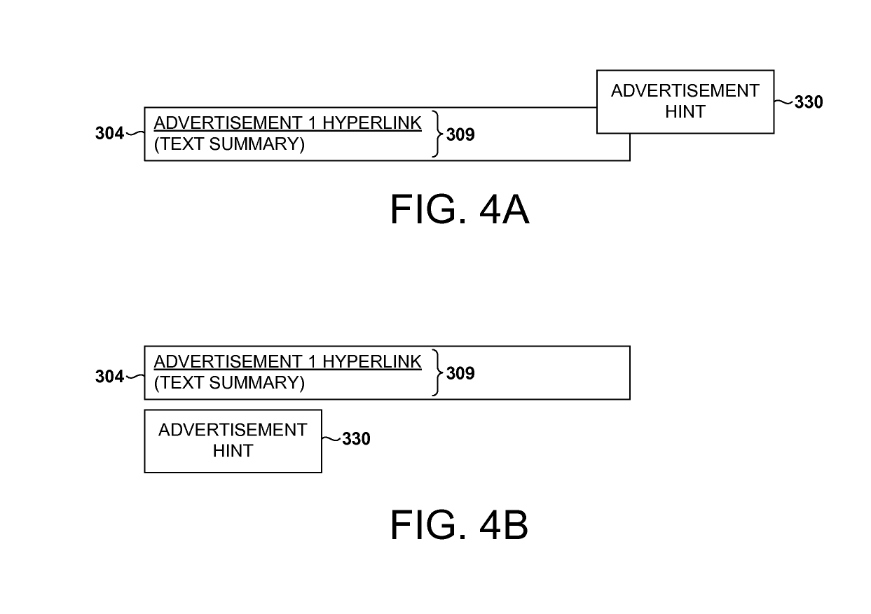

FIGS. 4A and 4B illustrate exemplary locations in which advertisement hint 330 of FIG. 3 appears relative to advertisement area 304. In FIG. 4A, advertisement hint 330 overlaps the right-hand corner of advertisement area 304. In FIG. 4B, advertisement hint 330 is located below advertisement area 304. Advertisement hint 330 can be located anywhere proximate to advertisement area 304 and can overlap, border, or be located next to advertisement area 304. In some embodiments, if advertisement hint 330 is located below, above, or in any other position relative to advertisement area 304 that would obscure or interfere with other advertisements, search result, or other content on search results page 300, then the other content is moved accordingly. For example, in FIG. 4B, user interaction with advertisement area 304 causes advertisement hint 330 to appear below advertisement area 304. Advertisement hint 330 would then partially obscure advertisement 315. To avoid such interference with advertisement 315, advertisement area 310 that displays advertisement 315, along with search result areas 316 and 322 and any other content below advertisement area 304, is moved down to accommodate the appearance of advertisement hint 330.

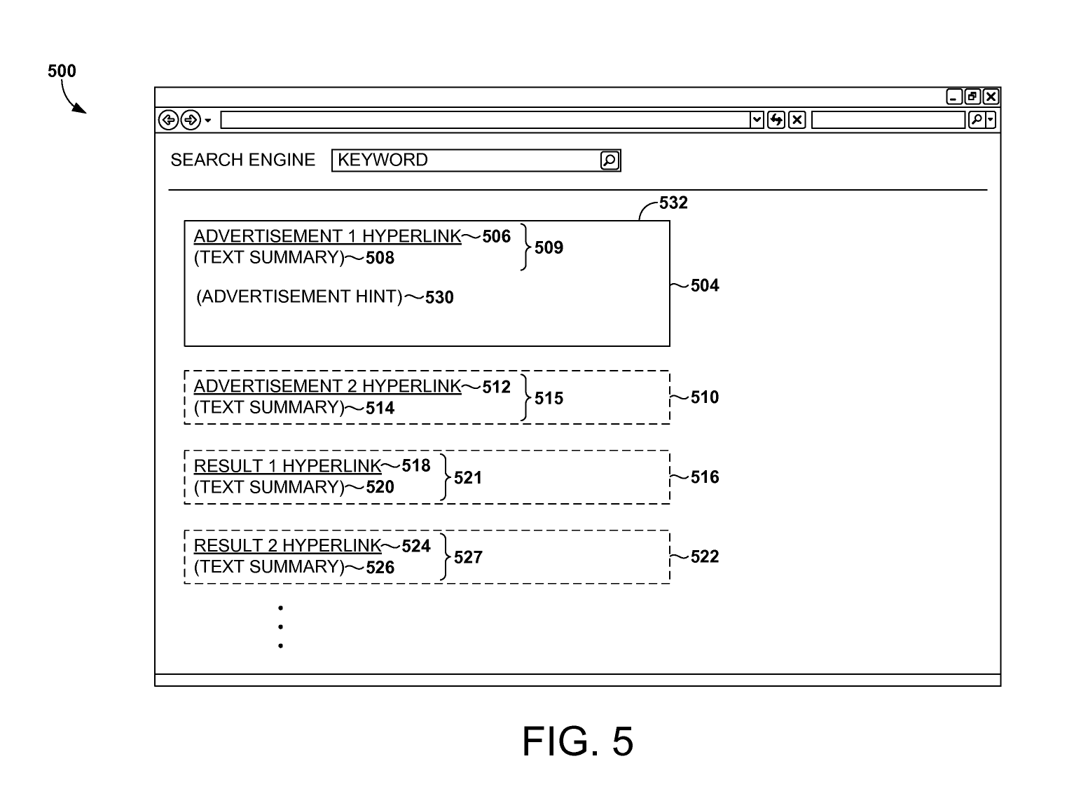

FIG. 5 illustrates embodiments in which an advertisement hint is incorporated into the advertisement area displaying an advertisement rather than the advertisement hint being a separate item. Search results page 500 includes search advertisement area 504. Search advertisement area 504 displays a search advertisement 509 comprising advertisement 1 hyperlink 506 and corresponding text summary 508. Search advertisement area 510 displays a search advertisement 515 comprising advertisement 2 hyperlink 512 and corresponding text summary 514. Search result area 516 displays a search result 521 comprising result 1 hyperlink 518 and corresponding text summary 520. Search result area 522 displays a search result 527 comprising result 2 hyperlink 524 and corresponding text summary 526.

In FIG. 5, a user has interacted with advertisement area 504. The interaction with advertisement area 504 caused advertisement area 504 to expand, caused advertisement hint 530 to appear in the expanded advertisement area, and caused advertisement area 510 and search result areas 516 and 522 to move down to accommodate the expanded advertisement area. The user interaction in FIG. 5 has also caused advertisement area 504 to be outlined to indicate that advertisement hint 530 is associated with advertisement area 504. In one embodiment, advertisement hint 530 is additional text content that was not included in advertisement 509. In such an embodiment, advertisement hint 530 may be a continuation of text summary 508 such that it appears to a user that text summary 508 of advertisement 509 has simply expanded. As discussed with regard to FIG. 3, advertisement hint 530 may be anything related to the advertisement, including an image of a logo, product, web page, or spokesperson associated with the advertisement. Advertisement hint 530 may also include action links that, when interacted with by a user, perform an action or navigate a user to a website or web page associated with the advertisement. Although advertisement area 504 is shown expanding downward in FIG. 5, advertisement area 504 may expand in any direction such that advertisement hint 530 may be located in any position in the expanded advertisement area.

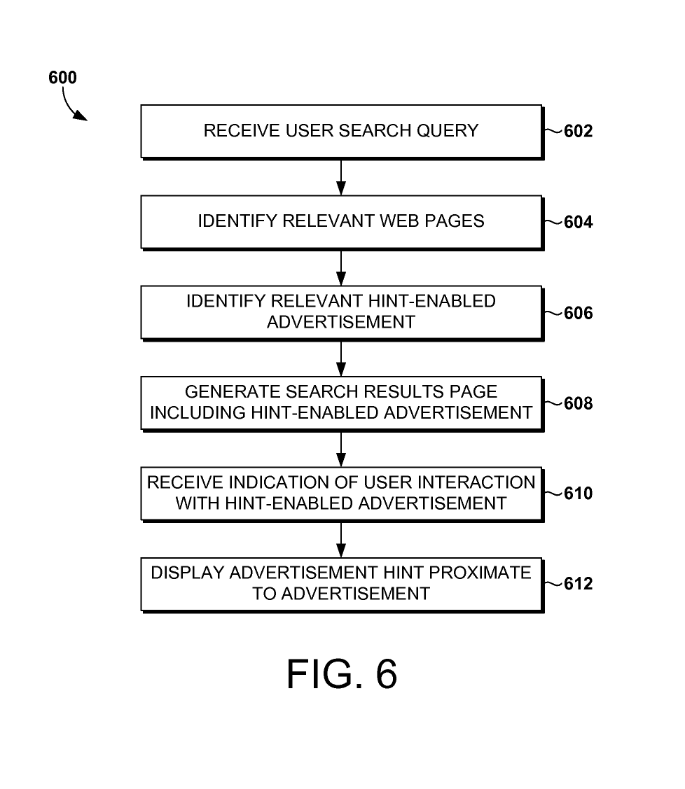

FIG. 6 illustrates an exemplary method 600 for providing advertisement hints. In step 602, a user search query is received. In step 604, a plurality of web pages relevant to the search query are identified. In step 606, an advertisement that is hint-enabled such that user interaction with the advertisement causes an advertisement hint to appear proximate to the advertisement is identified. A search results page is generated in step 608, the search results page including at least one of the identified web pages relevant to the user query and the identified hint-enabled advertisement. In step 610, an indication of user interaction with the hint-enabled advertisement is received. In response to the received indication of user interaction, instructions are transmitted in step 612 to display the advertisement hint proximate to the advertisement.

In some embodiments, all advertisements displayed on a search results page for a search provider are hint-enabled. In such embodiments, advertisers may specify advertisement hints they would like displayed, or the search provider may automatically generate an advertisement hint at the time the ad is created that is, for example, the advertiser's logo or most well-known product. In other embodiments, the advertisement hint that is displayed is dynamically generated in response to the user interaction. In still other embodiments, when an advertiser creates a search advertisement, the advertiser selects whether the search ad is hint-enabled and may also specify the advertisement hint or hints that will be displayed upon user interaction. In some embodiments, action links included in the advertisement hint are automatically generated by the search provider or other third party rather than created by an advertiser.

Advertisers typically purchase search advertisements based on a user-entered keyword. For example, a first advertiser may purchase the rights to have search ads displayed on a search results page generated when a user searches for the word “car.” In some embodiments, an advertiser may purchase multiple keywords for the same advertisement. The advertiser may specify different advertisement hints based on which of the multiple keywords a user entered. Thus, the first advertiser may create a single search ad and purchase the keywords “car” and “automobile.” The first advertiser may decide, for example, that older users are more likely to search for “automobile” and younger users are more likely to search for “car” and create a different advertisement hint for each of these keywords that is more appropriate for the likely user.

Pricing models and priority determinations for advertisements may be adjusted to incorporate hint-enabled search ads. Exemplary pricing models and priority determinations for voice-enabled text advertisements are described in detail in the following co-pending U.S. patent applications, all filed on Mar. 17, 2010: U.S. patent application Ser. No. 12/726,067, titled “Voice-Enabled Text Advertisements;” U.S. patent application Ser. No. 12/725,989, titled “Pricing for Voice-Enabled Text Advertisements;” and U.S. patent application Ser. No. 12/726,035, titled “Voice Customization for Voice-Enabled Text Advertisements.” These three co-pending applications are hereby incorporated by reference in their entirety. The pricing models and priority determinations described in the three above applications for voice-enabled advertisements can be modified for hint-enabled advertisements.

Typically, bids are made on a cost-per-impression (CPI) or cost-per-click (CPC) basis. An advertiser bids a monetary amount it is willing to pay each time an advertisement is displayed or each time a user selects or clicks on a displayed advertisement. Advertising system providers may rank advertisements by a CPI bid and/or a CPC bid to determine which advertisements should be selected for a given request for advertisements and/or which advertisement should be displayed as a primary advertisement. For instance, Airline A may bid $1.00 for each user that accesses its information as a result of its advertisement being selected and presented while Airline B may bid $1.75 for each user that accesses its information upon its advertisement being selected and presented.

In this example, Airline B would “win” the bid and, accordingly, its advertisement may be selected to be presented. Further, Airline B's advertisement may be selected to be displayed as the primary advertisement and be placed in a prominent position. For instance, in the context of search, Airline B's advertisement may be placed a location at the top and center of the search results page or at the top of a list of advertisements. Advertisements with higher CPC bids may be placed in more prominent positions since a more prominent advertisement, or primary advertisement, has a higher likelihood of being selected by a user, thus, increasing the amount of revenue generated from CPC bids.

Alternatively, an advertisement delivery system may rank the advertisements according to a monetization value associated with the advertisements. Monetization values for search advertisements may be calculated based on both a CPC bid and a click-through rate (CTR) associated with the advertisement. CTR' s are the rate at which users have clicked on a particular advertisement when presented. The product of the CPC bid and the CTR (CPC bid×CTR) is the monetization value and the highest product, i.e., the highest monetization value, may be ranked higher than other advertisements and, in turn, may be more likely to be selected for presentation. For instance, if Airline B's advertisement has a CTR of 5% then the monetization value of the advertisement may be calculated to be 0.0875 (1.75*0.05). If Airline A's advertisement has a CTR of 10% then the monetization value of the advertisement may be calculated to be 0.10 (1.00*0.10). In this case, Airline A's advertisement will “win” and be displayed in a more prominent position than Airline B's advertisement.

In accordance with embodiments of the present invention, hint-enabled text advertisements may be selected for presentation based on a variety of bid values and/or historical information. Advertisers may still submit a CPC bid, and a CTR may still be associated with each hint-enabled search advertisement. In addition to traditional bid options such as bidding on clicks, user performance, or the like, advertisers may have an option to bid for an advertisement hint. A cost-per-hint (CPH) bid may be included in a calculation of a monetization value for a hint-enabled search advertisement.

A variety of formulas may be used within various embodiments of the invention to calculate the monetization value of hint-enabled search ads. The formulas may incorporate a variety of different monetization factors to rank advertisements and, in turn, select search advertisements and hint-enabled search advertisements for presentation.

In a specific embodiment, a monetization value may be calculated using, for instance, the following equation:

MV(h)=CPH/1000+CPC(h)*CTR(h)

Wherein MV(h) represents the monetization value of a hint-enabled search advertisement, CPH/1000 is the cost-per-hint that the advertiser has bid for advertisement hints per every one thousand impressions of the hint-enabled advertisement, CPC(h) is the hint-cost-per-click bid submitted by the advertiser for the hint-enabled search advertisement, and CTR(h) is the hint-click-through-rate for the hint-enabled search advertisement. The CPC(h) may be based on clicks while the hint is displayed, while the hint is not activated, once the hint as disappeared, or the like.

In another specific embodiment, a price estimation may be performed for an advertiser using, for instance, the following equation:

Monthly $=I*CPI/1000+H*CPH/1000+C*CPC

Wherein Monthly $ represents an estimated monthly amount owed by the advertiser, I is a number of impressions, CPI/1000 is a cost-per-impression bid per every 1000 times the advertisement is displayed, H is a number of times a hint is displayed, CPH is a cost-per-hint bid submitted by the advertiser, C is a number of clicks, and CPC is a cost-per-click bid submitted by the advertiser. In the above exemplary equation, the CPI and CPH bids are the cost-per-impression bid and/or cost-per-hint bid per 1000 times the advertisement has been displayed or the hint has been presented or will be presented. Alternatively, the CPI and/or CPH could be for N number of times the advertisement is displayed and/or the advertisement hint is presented, wherein N is any number.

Embodiments of the present invention have been discussed with regard to hint-enabled search ads. Hint-enabled display ads, which are typically displayed on a web page when the user navigates to the page, are also contemplated. Hint-enabled display ads may be text-based ads or rich media ads. The user interfaces described herein may be implemented on tablet computing devices, smart phones, PDAs, or other wireless devices.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. One or more computer storage media storing computer-executable instructions for a keyword search query results graphical user interface, the user interface comprising:
a keyword search query entry area capable of receiving a user keyword search query;
at least one search result area, each search result area displaying an Internet web page link and corresponding text relevant to a received user keyword search query; and
at least one search advertisement area, each search advertisement area displaying an advertisement comprising an Internet web page link and corresponding text,
wherein user interaction with the advertisement area causes an advertisement hint to appear proximate to the advertisement area, and
wherein the advertisement hint is related to the advertisement.

2. The media of claim 1, wherein the advertisement hint is an image of a logo, product, web page, or spokesperson associated with the advertisement.

3. The media of claim 1, wherein the advertisement hint includes action links that, when selected by a user, perform an action or navigate a user to a website associated with the advertisement.

4. The media of claim 1, wherein the advertisement hint includes additional text content that was not included in the advertisement.

5. The media of claim 1, wherein the user interaction is hovering a selection indicator over the advertisement area.

6. The media of claim 1, wherein the advertisement area is emphasized upon user interaction with the advertisement area such that a user can easily identify the advertisement to which the advertisement hint corresponds.

7. The media of claim 1, wherein each search advertisement area containing an advertisement for which user interaction causes an advertisement hint to appear is indicated as hint-enabled prior to the user interaction.

8. The media of claim 1, wherein the advertisement hint is displayed proximate to the right side of the advertisement area.

9. The media of claim 1, wherein the advertisement hint overlaps the advertisement area.

10. The media of claim 1, wherein the advertisement hint is displayed beneath the advertisement area, and wherein other search advertisement areas beneath the search advertisement area for which the advertisement hint is displayed are moved down to accommodate the advertisement hint.

11. One or more computer storage media storing computer-executable instructions for performing a method for providing advertisement hints, the method comprising:
receiving a search query from a user;
identifying a plurality of web pages relevant to the search query;
identifying an advertisement that is hint-enabled such that user interaction with the advertisement causes an advertisement hint to appear proximate to the advertisement;
generating a search results page including at least one of the identified web pages relevant to the user query and the identified hint-enabled advertisement;
receiving an indication of user interaction with the hint-enabled advertisement; and
in response to the received indication of user interaction, transmitting instructions to display the advertisement hint proximate to the advertisement.

12. The media of claim 11, wherein the advertisement hint is an image of a logo, product, web page, or spokesperson associated with the advertisement.

13. The media of claim 11, wherein the advertisement hint includes action links that, when selected by a user, perform an action or navigate a user to a website associated with the advertisement.

14. The media of claim 11, wherein the advertisement hint includes additional text content that was not included in the advertisement.

15. The media of claim 11, wherein the advertisement hint that is displayed is dynamically generated in response to receiving the indication of user interaction.

16. The media of claim 11, wherein the advertisement was specified as hint-enabled at the time the advertisement was created.

17. The media of claim 16, wherein the advertisement hint that is displayed was specified at the time the advertisement was created.

18. The media of claim 16, wherein the advertisement has a plurality of associated advertisement hints, and wherein the advertisement hint displayed in response to the received indication of user interaction depends upon the received user keyword search query.

19. One or more computer storage media storing computer-executable instructions for a keyword search query results graphical user interface, the user interface comprising:
a keyword search query entry area capable of receiving a user keyword search query;
at least one search result area, each search result area displaying an Internet web page link and corresponding text relevant to a received user keyword search query; and
at least one search advertisement area, each search advertisement area displaying an advertisement comprising an Internet web page link and corresponding text,
wherein user interaction with the advertisement area causes the advertisement area to expand, causes an advertisement hint to appear in the expanded advertisement area, and causes search advertisement and search result areas below the expanded area to move down to accommodate the expanded advertisement area, and
wherein the advertisement hint is related to the advertisement.

20. The media of claim 19, wherein the advertisement hint includes at least one of: an image of a logo, product, web page, or spokesperson associated with the advertisement; action links that, when selected by a user, perform an action or navigate a user to a website associated with the advertisement; and additional text content that was not included in the advertisement.
